(19) United States
(12) Patent Application Publication
(10) Pub. No.: US 2013/0188609 A1
(43) Pub. Date: Jul. 25, 2013

(54) COMMUNICATION SYSTEM, COMMUNICATION METHOD, AND CONTROL DEVICE

(71) Applicant: FUJITSU LIMITED, Kawasak-shi (JP)

(72) Inventors: Yuya HARADA, Kawasaki (JP); Dai Kimura, Yokohama (JP); Takaharu Kobayashi, Yamato (JP)

(73) Assignee: FUJITSU LIMITED, Kawasaki-shi (JP)

(21) Appl. No.: 13/734,568

(22) Filed: Jan. 4, 2013

(30) Foreign Application Priority Data
Jan. 25, 2012 (JP) 2012-013522

(51) Int. Cl. H04W 72/04

(52) U.S. Cl. CPC H04W 72/044
USPC 370/336

(57) ABSTRACT

A communication system includes: a plurality of mobile stations each of which performs wireless communication with a base station; a plurality of base stations each of which selects, for each transmission timing, a mobile station which performs wireless communication for transmission of a radio signal with the base station, from mobile stations that are coupled to the base station among the plurality of mobile stations; and a control device that calculates, for each transmission timing, a parameter for each of a communication source in the transmission of the radio signal, the parameter being calculated so that a communication quality of each of the mobile stations selected for the transmission timing by each of the plurality of base stations satisfies a certain condition; wherein the each of the communication source transmits the radio signal at each transmission timing, using a parameter for the communication source calculated by the control device.

### CROSS-REFERENCE TO RELATED APPLICATION

This application is based upon and claims the benefit of priority of the prior Japanese Patent Application No. 2012-013522, filed on Jan. 25, 2012, the entire contents of which are incorporated herein by reference.

### FIELD

The embodiments discussed herein are related to a communication system, a communication method, and a control device.

### BACKGROUND

A mobile communication system in which wireless communication is performed between a base station and a mobile station (for example, see Japanese Laid-open Patent Publication No. 2004-72157 and Japanese Laid-open Patent Publication No. 2010-114517) includes, for example, a centralized mobile communication system which includes a controller that grasps a state of the whole system by coupling to base stations. In addition, the mobile communication system also includes an autonomous mobile communication system in which the controller is not provided.

In the autonomous mobile communication system, an effect of the improvement of a throughput may be obtained in each base station, because base stations individually perform interference control, etc. However, it is difficult to take the imbalance of traffic between base stations and an amount of interference of a base station for another adjacent base station into account. Therefore, in the autonomous mobile communication system, some throughputs in the system may be improved. However, the throughput of the system as a whole may be reduced.

### SUMMARY

According to an aspect of the invention, a communication system includes: a plurality of mobile stations each of which performs wireless communication with a base station; a plurality of base stations each of which selects, for each transmission timing, a mobile station which performs wireless communication for transmission of a radio signal with the base station, from mobile stations that are coupled to the base station among the plurality of mobile stations; and a control device that calculates, for each transmission timing, a parameter for each of a communication source in the transmission of the radio signal, the parameter being calculated so that a communication quality of each of the mobile stations selected for the transmission timing by each of the plurality of base stations satisfies a certain condition; wherein the each of the communication source transmits the radio signal at each transmission timing, using a parameter for the communication source calculated by the control device.

The object and advantages of the invention will be realized and attained by means of the elements and combinations particularly pointed out in the claims.

It is to be understood that both the foregoing general description and the following detailed description are exemplary and explanatory and are not restrictive of the invention, as claimed.

### BRIEF DESCRIPTION OF DRAWINGS

FIG. 1 is a diagram illustrating an exemplary configuration of a communication system according to an embodiment;

FIG. 2A is a diagram illustrating an example of a state before control of transmission powers in downlink;

FIG. 2B is a diagram illustrating a first control example of transmission powers in downlink;

FIG. 2C is a diagram illustrating a second control example of transmission powers in downlink;

FIG. 3A is a diagram illustrating an example of a hardware configuration of a base station;

FIG. 3B is a diagram illustrating an example of a hardware configuration of a control device;

FIG. 4 is a diagram illustrating an exemplary application of the communication system according to the embodiment;

FIG. 5 is a diagram illustrating an example of a configuration of the base station;

FIG. 6 is a diagram illustrating an example of a configuration of a controller;

FIG. 7 is a sequence diagram illustrating an example of operations of the communication system;

FIG. 8 is a diagram illustrating a first example of scheduling that takes a time difference into account;

FIG. 9 is a diagram illustrating a second example of the scheduling that takes a time difference into account;

FIG. 10 is a flowchart illustrating an example of optimization calculation by the controller;

FIG. 11 is a diagram illustrating an example of cell placement in the communication system;

FIG. 12 is a diagram illustrating an example of a propagation loss between each base station and a mobile station; and

FIG. 13 is a diagram illustrating an example of a transmission power pattern in each base station.

### DESCRIPTION OF EMBODIMENTS

A communication system, a communication method, and a control device according to the embodiments are described in detail with reference to accompanying drawings.

While inventing the present embodiments, observations were made regarding a related art. Such observations include the following, for example.

In technologies of the related art, when the number of mobile stations that are coupled to base stations increases, there is less possibility of the presence of a parameter that improves throughput in each mobile station coupled to a base station. Therefore, it may be difficult in some cases to obtain an effect of improvement of a throughput by change of a parameter.

The disclosed embodiments are intended to solve the above-described problem. An aspect of the disclosed embodiments is to achieve a communication system, a communication method, a control device, and a base station that improve a throughput.

### Embodiments

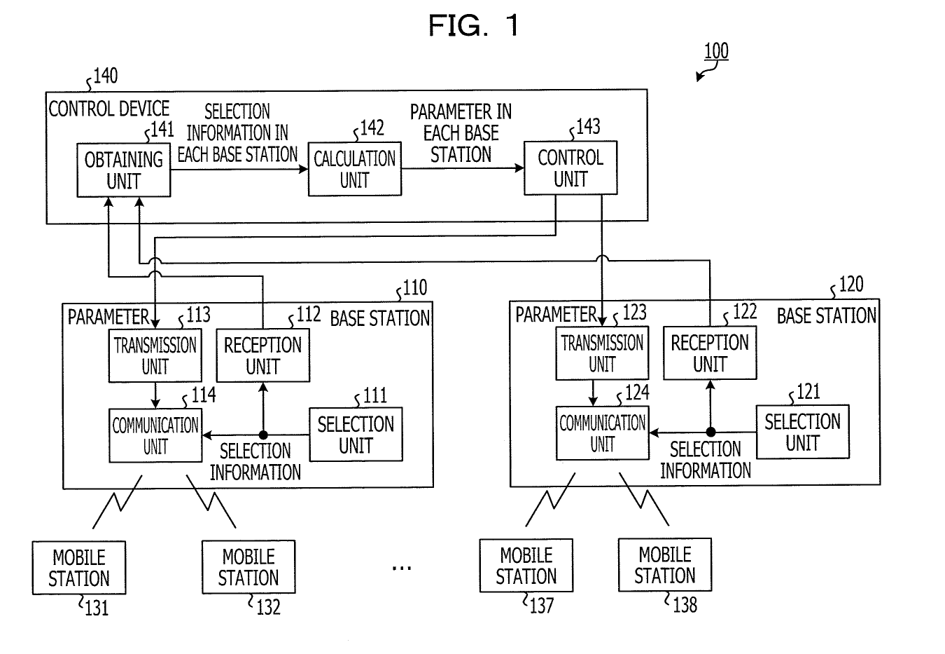

FIG. 1 is a diagram illustrating an exemplary configuration of a communication system according to an embodiment. As illustrated in FIG. 1, a communication system 100 according to the embodiment includes base stations 110 and 120, mobile stations 131 to 138, and a control device 140. The base stations 110 and 120 are, for example, base stations the cells of which are adjacent to each other.

Each of the mobile stations 131 to 138 performs transmission and reception of a radio signal to and from a base station, among the base stations 110 and 120, to which each of the mobile stations 131 to 138 is coupled at a transmission timing allocated by the base station. The transmission timing is, for example, each timing of time-division (common channel) in time division multiple access (TDMA) and is, for example, a sub-frame.

The control device 140 is a control device that controls parameters in the base stations 110 and 120 for wireless communication with the mobile stations 131 to 138. The control device 140 is, for example, a device that can perform communication with the base stations 110 and 120.

An example is described below in which the control device 140 controls parameters in downlink from the base stations 110 and 120 to the mobile stations 131 to 138. In addition, the control device 140 may control parameters in uplink from the mobile stations 131 to 138 to the base stations 110 and 120 (described later).

<Configuration of a Base Station>

The base station 110 includes a selection unit 111, a transmission unit 112, a reception unit 113, and a communication unit 114. The selection unit 111 selects, for a future transmission timing, a mobile station that is a transmission destination of a radio signal from mobile stations coupled to the base station 110 among the mobile stations 131 to 138. The selection unit 111 generates selection information indicating a mobile station selected for each transmission timing.

The selection information generated by the selection unit 111 may be, for example, selection information that associates, for each transmission timing, the selected mobile station with the transmission timing for which the selected mobile station is selected as a transmission destination. For example, the selection information includes information indicating the selected mobile station, and information indicating a sub-frame for which the selected mobile station is determined as a transmission destination (for example, a sub-frame number).

The selection unit 111 outputs the generated selection information to the transmission unit 112 and the communication unit 114. The transmission unit 112 transmits the selection information output from the selection unit 111 to the control device 140. The reception unit 113 receives from the control device 140 the parameter of the base station 110 calculated for each transmission timing by the control device 140, based on the selection information transmitted by the transmission unit 112. The reception unit 113 outputs the received parameter to the communication unit 114.

The communication unit 114 transmits, at each transmission timing, a radio signal to a mobile station indicated by the selection information output from the selection unit 111, using the parameter output from the reception unit 113. As a result, the radio signal can be transmitted to the mobile station while updating the parameter at each transmission timing.

The base station 120 includes a selection unit 121 a transmission unit 122, a reception unit 123, and a communication unit 124. The selection unit 121, the transmission unit 122, the reception unit 123, and the communication unit 124 of the base station 120 are similar to the selection unit 111, the transmission unit 112, the reception unit 113, and the communication unit 114 of the base station 110, respectively.

<Configuration of a Control Device>

The control device 140 includes an obtaining unit 141, a calculation unit 142, and a control unit 143. The obtaining unit 141 obtains selection information from the base stations 110 and 120. The selection information obtained by the obtaining unit 141 is, for example, selection information indicating a result obtained by selecting, by the base station 110 or 120, for each transmission timing, a mobile station that is a transmission destination of a radio signal from mobile stations that are coupled to the base station 110 or 120, among the mobile stations 131 to 138. The obtaining unit 141 outputs the obtained selection information of each base station to the calculation unit 142.

The calculation unit 142 calculates, for each transmission timing, a parameter of each of the base stations 110 and 120 in the transmission of a radio signal in downlink based on the selection information output from the obtaining unit 141. The parameter calculated by the calculation unit 142 is, for example, a parameter in which a communication quality of respective mobile stations selected for the same transmission timing by the base stations 110 and 120 satisfies a certain condition.

The certain condition is, for example, a condition that a minimum value (lowest quality) of a communication quality of respective mobile stations becomes maximum. Alternatively, the certain condition may be a condition that an average value of a communication quality of the mobile stations becomes maximum. The calculation unit 142 notifies the control unit 143 of the calculated parameters of the base stations 110 and 120.

The parameter may include, for example, a parameter related to a transmission power of a radio signal. In addition, the parameter may include a parameter related to a beam pattern of a radio signal. In addition, the parameter may include a parameter related to a transmission frequency band of a radio signal. In addition, the parameter may include a parameter related to coordinated transmission between the base stations 110 and 120.

The control unit 143 controls the base station 110 to transmit a radio signal to the mobile station selected by the base station 110, using the parameter of the base station 110 received from the calculation unit 142 at each transmission timing. In addition, the control unit 143 controls the base station 120 to transmit a radio signal to the mobile station selected by the base station 120, using the parameter of the base station 120 received from the calculation unit 142 at each transmission timing. For example, the control unit 143 performs parameter control by transmitting the parameters of the base stations 110 and 120 received from the calculation unit 142 to the base stations 110 and 120.

The case in which the control device 140 is a device different from the base stations 110 and 120, and alternatively, the control device 140 may be, for example, a device that is provided in the base station 110 and can communicate with the base station 120. In this case, the base station 110 may have a configuration in which the transmission unit 112 is omitted and the selection unit 111 outputs selection information to the obtaining unit 141 of the control device 140. In addition, the base station 110 may have a configuration in which the reception unit 113 is omitted and the control unit 143 of the control device 140 outputs a parameter to the communication unit 114 of the base station 110.

A case in which a transmission timing is a sub-frame is described below.

(Control Example of a Transmission Power in Downlink)

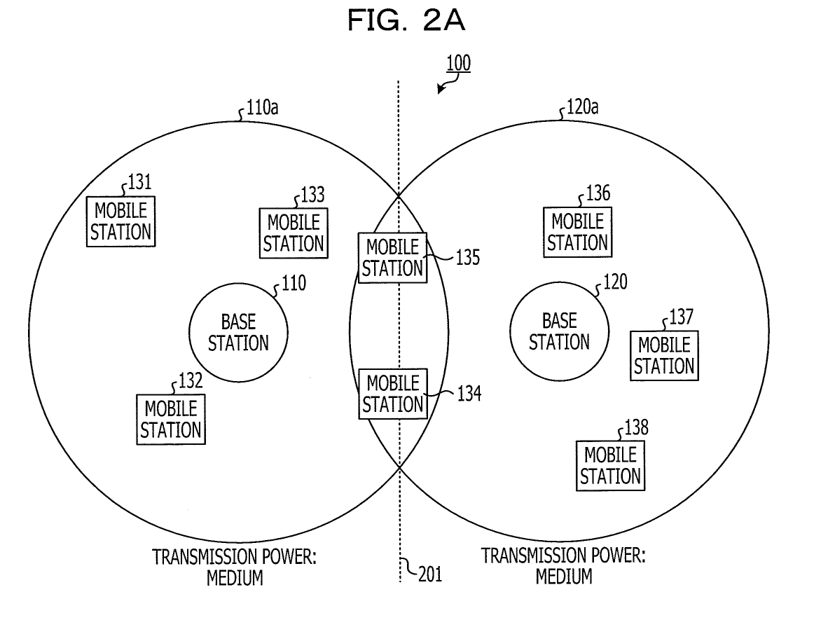

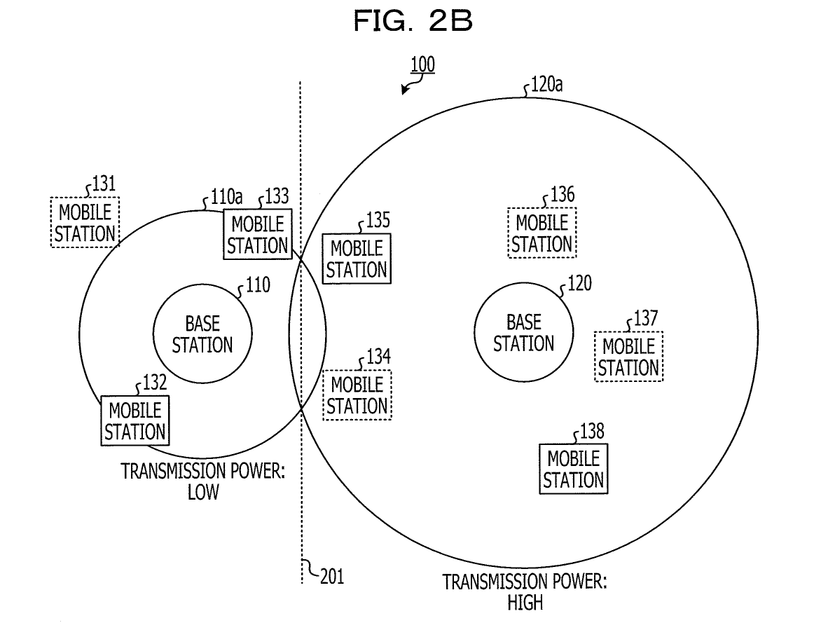

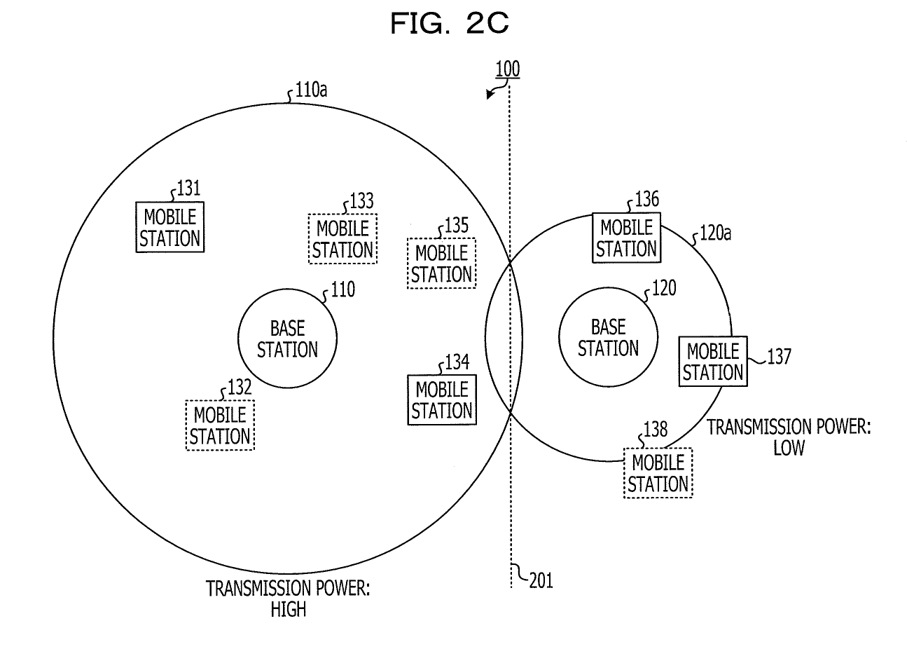

FIG. 2A is a diagram illustrating an example of a state before control of transmission powers in downlink. In FIG. 2A, parts similar to the parts illustrated in FIG. 1 are denoted by the same reference numerals, and the description thereof is omitted. A cell 110a is a cell (coverage area) of the base station 110 in which each mobile station can perform wireless communication with the base station 110. A cell 120a is a cell of the base station 120 in which each mobile station can perform wireless communication with the base station 120. A cell boundary 201 is a boundary between the cell 110a and the cell 120a.

The mobile stations 131 to 133 are located in the cell 110a. The mobile stations 134 and 135 are located in an overlapping portion between the cells 110a and 120a, that is, the cell boundary 201. The mobile stations 136 to 138 are located in the cell 120a. In the example illustrated in FIG. 2A, the mobile stations 131 to 134 are coupled to the base station 110, and the mobile stations 135 to 138 are coupled to the base station 120. The mobile stations 134 and 135 are located in the cell boundary 201. The mobile station 134 is subject to interference from the base station 120 to which the mobile station 134 is not coupled, so that the throughput tends to decrease. The mobile station 135 is subject to interference from the base station 110 to which the mobile station 135 is not coupled, so that the throughput tends to decrease.

FIG. 2B is a diagram illustrating a first control example of transmission powers in downlink. In FIG. 2B, parts similar to the parts illustrated in FIG. 2A are denoted by the same reference numerals, and the description thereof is omitted. FIG. 2B illustrates a control example of transmission powers in downlink in a certain sub-frame. In the sub-frame of FIG. 2B, among the mobile stations 131 to 134 that are coupled to the base station 110, the mobile stations 132 and 133 (solid line) are scheduled by the base station 110, and the mobile stations 131 and 134 (dotted line) are not scheduled.

In addition, in the sub-frame of FIG. 2B, among the mobile stations 135 to 138 that are coupled to the base station 120, the mobile stations 135 and 138 (solid line) are scheduled by the base station 120, and the mobile stations 136 and 137 (dotted line) are not scheduled. As described above, in the sub-frame of FIG. 2B, among the mobile stations 134 and 135 in which the throughputs tend to decrease, the mobile station 135 is scheduled, and the mobile station 134 is not scheduled.

In this case, as illustrated in FIG. 2B, the control device 140 (see FIG. 1) controls the cell 110a to become relatively small and controls the cell 120a to become relatively large by setting the transmission power of the base station 110 to “low” and setting the transmission power of the base station 120 to “high”. As a result, the cell boundary 201 can be displaced toward the base station 110. Therefore, a signal to interference and noise ratio (SINR) of the mobile station 135 is improved, thereby improving the throughput.

In addition, for example, radio waves from the base station 110 are difficult to reach the mobile station 131 because the cell 110a is controlled to become relatively small. However, the mobile station 131 is not scheduled in the sub-frame of FIG. 2B, so that an effect on the throughput of the mobile station 131 due to the relatively small cell 110a can be avoided.

FIG. 2C is a diagram illustrating a second control example of transmission powers in downlink. In FIG. 2C, parts similar to the parts illustrated in FIG. 2A are denoted by the same reference numerals, and the description thereof is omitted. FIG. 2C illustrates a control example of transmission powers in downlink in a sub-frame different from the sub-frame of FIG. 2B. In the sub-frame of FIG. 2C, among the mobile stations 131 to 134 that are coupled to the base station 110, the mobile stations 131 and 134 are scheduled by the base station 110, and the mobile stations 132 and 133 are not scheduled.

In addition, in the sub-frame of FIG. 2C, among the mobile stations 135 to 138 that are coupled to the base station 120, the mobile stations 136 and 137 are scheduled by the base station 120, and the mobile stations 135 and 138 are not scheduled. As described above, in the sub-frame of FIG. 2C, among the mobile stations 134 and 135 in which the throughputs tend to decrease, the mobile station 134 is scheduled, and the mobile station 135 is not scheduled.

In this case, as illustrated in FIG. 2C, the control device 140 (see FIG. 1) controls the cell 110a to become relatively large and controls cell 120a to become relatively small by setting the transmission power of the base station 110 to “large” and setting the transmission power of the base station 120 to “small”. As a result, the cell boundary 201 can be displaced toward the base station 120. Therefore, an SINR of the mobile station 134 is improved, thereby improving the throughput.

In addition, for example, radio waves from the base station 120 are difficult to reach the mobile station 138 because the cell 120a is controlled to become relatively small. However, the mobile station 138 is not scheduled in the sub-frame of FIG. 2C, so that an effect on the throughput of the mobile station 138 due to the relative small cell 120a can be avoided.

As illustrated in FIGS. 2A to 2C, the control device 140 optimizes, for each sub-frame, a parameter such as a transmission power by focusing on the mobile station allocated to the target sub-frame. As a result, since the number of mobile stations that are targets to be optimized is reduced, there is high possibility of the presence of the parameter that improves the throughput. Therefore, improvement of the throughput of the communication system 100 as a whole, uniformity of the throughputs between the mobile stations, etc. are realized easily.

(Hardware Configuration)

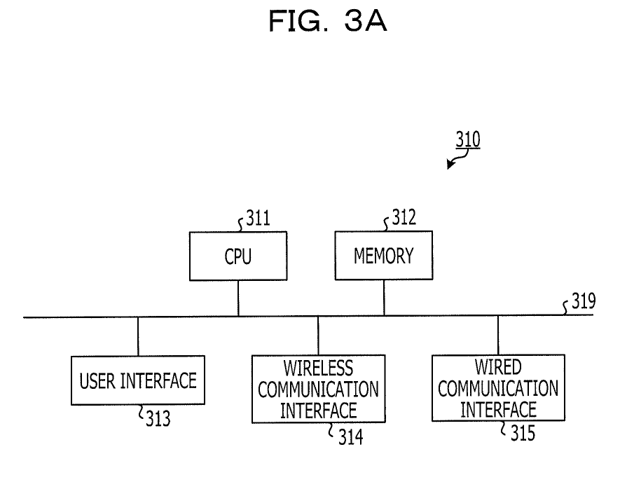

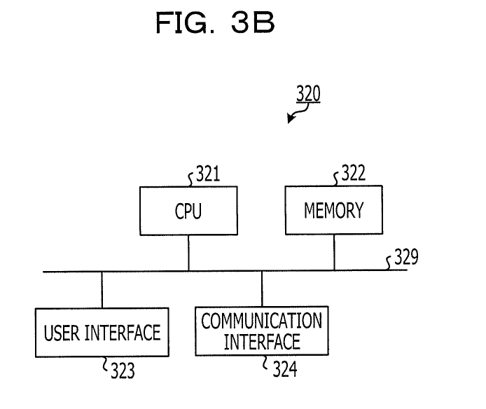

FIG. 3A is a diagram illustrating an example of a hardware configuration of a base station. Each of the base stations 110 and 120 illustrated in FIG. 1 can be realized, for example, by a communications device 310 illustrated in FIG. 3A. The communications device 310 includes a central processing unit (CPU) 311, a memory 312, a user interface 313, a wireless communication interface 314, and a wired communication interface 315. The CPU 311, the memory 312, the user interface 313, the wireless communication interface 314, and the wired communication interface 315 are coupled to each other through a bus 319.

The CPU 311 controls the whole communications device 310. In addition, the communications device 310 may include a plurality of CPUs 311. The memory 312 includes, for example, a main memory and an auxiliary memory. The main memory is, for example, a random access memory (RAM), and used as a work area of the CPU 311. The auxiliary memory is, for example, a nonvolatile memory such as a hard disk, an optical disk, and a flash memory. In the auxiliary memory, various programs that operate the communications device 310 are stored. The program stored in the auxiliary memory is loaded by the main memory and executed by the CPU 311.

The user interface 313 includes, for example, an input device that accepts an operation input from a user and an output device that outputs information to the user. The input device can be realized, for example, by a key (for example, a keyboard), a remote controller, etc. The output device can be realized, for example, by a display, a speaker, etc. In addition, the input device and the output device may be realized by a touch-screen, etc. The user interface 313 is controlled by the CPU 311.

The wireless communication interface 314 is a communication interface that performs wireless communication with the outside of the communications device 310 (for example, with the mobile stations 131 to 138). The wireless communication interface 314 is controlled by the CPU 311.

The wired communication interface 315 is a communication interface that performs wired communication with the outside of the communications device 310 (for example, with the control device 140). The wired communication interface 315 is controlled by the CPU 311.

The selection units 111 and 121 illustrated in FIG. 1 can be realized, for example, by the CPU 311. The transmission units 112 and 122 and the reception units 113 and 123 illustrated in FIG. 1 can be realized, for example, by the wired communication interface 315. The communication units 114 and 124 illustrated in FIG. 1 are realized, for example, by the wireless communication interface 314.

FIG. 3B is a diagram illustrating an example of a hardware configuration of a control device. The control device 140 illustrated in FIG. 1 can be realized, for example, by a communications device 320 illustrated in FIG. 3B. The communications device 320 includes a CPU 321, a memory 322, a user interface 323, and a communication interface 324. The CPU 321, the memory 322, the user interface 323, and the communication interface 324 are coupled to each other through a bus 329.

The CPU 321, the memory 322, and the user interface 323 are similar to the CPU 311, the memory 312, and the user interface 313 that are illustrated in FIG. 3A, respectively. The communication interface 324 is a communication interface that performs wired communication with the outside of the communications device 320 (for example, with the base stations 110 and 120). The communication interface 324 is controlled by the CPU 321.

The obtaining unit 141 and the control unit 143 that are illustrated in FIG. 1 can be realized, for example, by the communication interface 324. The calculation unit 142 illustrated in FIG. 1 can be realized, for example, by the CPU 321.

When the control device 140 is provided in the base station 110 or the base station 120, the control device 140 may be realized by the communications device 310 illustrated in FIG. 3A. In this case, the obtaining unit 141 and the control unit 143 that are illustrated in FIG. 1 may be realized by the wired communication interface 315 illustrated in FIG. 3A. In addition, in this case, the calculation unit 142 illustrated in FIG. 1 may be realized by the CPU 311 illustrated in FIG. 3A.

(Exemplary Application of the Communication System According to the Embodiment)

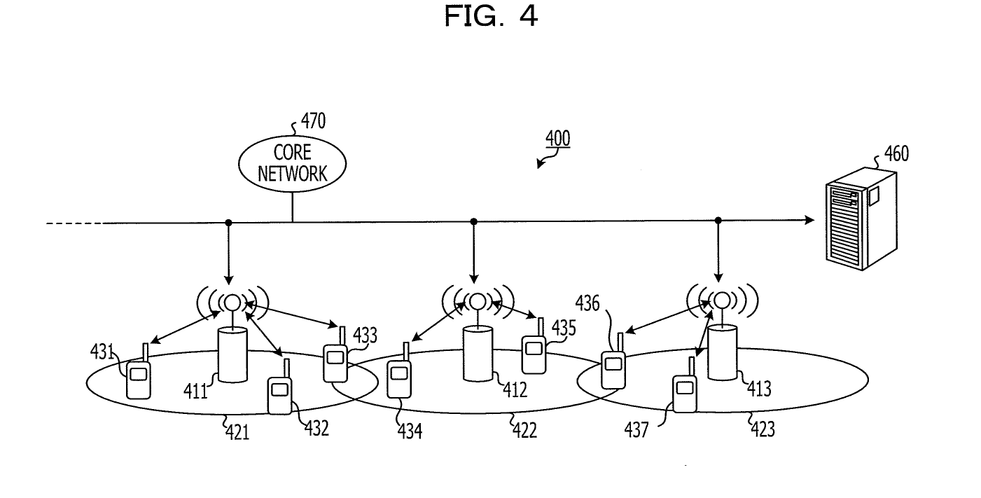

FIG. 4 is a diagram illustrating an exemplary application of the communication system according to the embodiment. A communication system 400 illustrated in FIG. 4 is a Long Term Evolution (LTE) system obtained by applying LTE, LTE-Advanced, etc. to the communication system 100 illustrated in FIG. 1. As illustrated in FIG. 4, the communication system 400 includes base stations 411 to 413, mobile stations 431 to 437, and a controller 460. Cells 421 to 423 are cells of the base stations 411 to 413, respectively.

Each of the base stations 110 and 120 illustrated in FIG. 1 may be applied to one of the base stations 411 to 413. Each of the mobile stations 131 to 138 illustrated in FIG. 1 may be applied to one of the mobile stations 431 to 437. The control device 140 illustrated in FIG. 1 may be applied to the controller 460.

Each of the mobile stations 431 to 433 is user equipment (UE) that is located in the cell 421 and coupled to the base station 411. The mobile station 433 is located in an overlapping portion between the cell 421 and the cell 422. Each of the mobile stations 434 and 435 is UE that is located in the cell 422 and coupled to the base station 412. Each of the mobile stations 436 and 437 is UE that is located in the cell 423 and coupled to the base station 413. The mobile station 436 is located in an overlapping portion between the cell 422 and the cell 423.

Each of the base stations 411 to 413 is, for example, an evolved Node B (eNB) that is coupled to an upper layer such as a core network 470 by a wire. In addition, each of the base stations 411 to 413 is also coupled to the controller 460. The controller 460 obtains information related to the base stations 411 to 413 and the mobile stations 431 to 437 that are coupled to the base stations 411 to 413 from the base stations 411 to 413. In addition, the controller 460 may be provided in one of the base stations 411 to 413.

(Configuration of a Base Station)

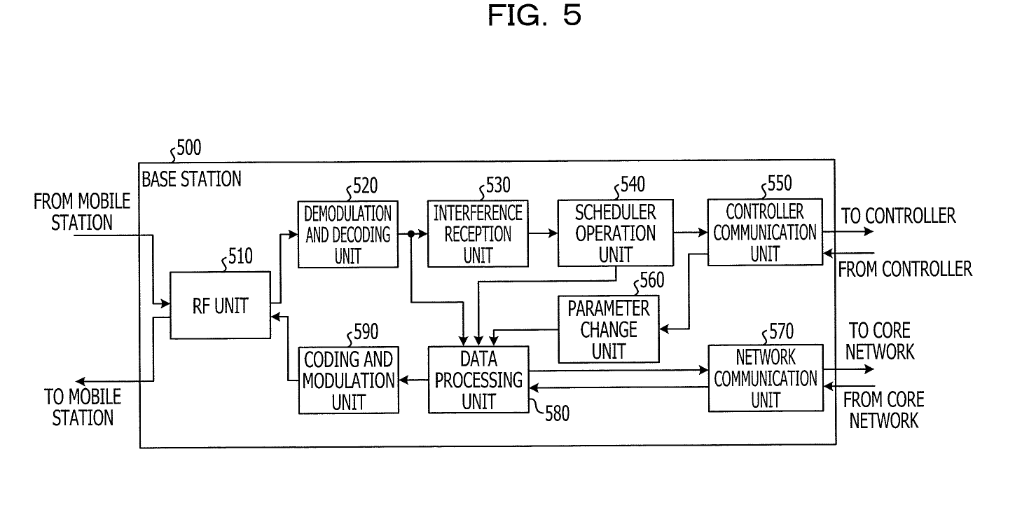

FIG. 5 is a diagram illustrating an example of a configuration of a base station. Each of the base stations 411 to 413 can be realized, for example, by a base station 500 illustrated in FIG. 5. The base station 500 includes, a radio frequency (RF) unit 510, a demodulation and decoding unit 520, an interference reception unit 530, a scheduler operation unit 540, a controller communication unit 550, a parameter change unit 560, a network communication unit 570, a data processing unit 580, and a coding and modulation unit 590.

The selection units 111 and 121 illustrated in FIG. 1 can be realized, for example, by the scheduler operation unit 540. The transmission units 112 and 122 and the reception units 113 and 123 illustrated in FIG. 1 can be realized, for example, by the controller communication unit 550. The communication units 114 and 124 illustrated in FIG. 1 can be realized, for example, by the RF unit 510.

The RF unit 510 converts a radio signal of an RF (high frequency) band received from a mobile station coupled to the base station 500 into a signal of a baseband. The RF unit 510 outputs the converted signal to the demodulation and decoding unit 520. In addition, the RF unit 510 converts a signal of the baseband output from the coding and modulation unit 590 into a radio signal of the RF band. The RF unit 510 transmits the converted radio signal to the mobile station coupled to the base station 500.

The demodulation and decoding unit 520 demodulates the signal output from the RF unit 510 and decodes the demodulated signal. The demodulation and decoding unit 520 outputs the data obtained by the decoding to the interference reception unit 530 and the data processing unit 580. The interference reception unit 530 receives interference information included in the data output from the demodulation and decoding unit 520. The interference information is, for example, information indicating a channel quality, etc. measured by the mobile station. The interference reception unit 530 outputs the received interference information to the scheduler operation unit 540.

The scheduler operation unit 540 performs scheduling so as to select, for each sub-frame, a mobile station that is a destination to which the base station 500 transmits a radio signal, based on the interference information output from the interference reception unit 530. The scheduler operation unit 540 outputs scheduling information indicating a result of the scheduling to the controller communication unit 550 and the data processing unit 580. The scheduling information corresponds to the above-described selection information. In addition, the scheduler operation unit 540 may store a sub-frame number indicating a corresponding sub-frame in the output scheduling information.

In addition, the scheduler operation unit 540 may also output information such as the number of mobile stations that are being coupled to the base station 500 and a propagation loss in each of the mobile stations that are being coupled to the base station 500, to the controller communication unit 550. The information on the propagation loss in each of the mobile stations that are being coupled to the base station 500 can be obtained, for example, from each of the mobile stations that are being coupled to the base station 500.

The controller communication unit 550 transmits the scheduling information output from the scheduler operation unit 540, to the controller 460 (see FIG. 4). In addition, the controller communication unit 550 transmits the information that is output from the scheduler operation unit 540 such as the number of mobile stations and the propagation loss, to the controller 460. In addition, the controller communication unit 550 receives a parameter transmitted from the controller 460. In addition, the controller communication unit 550 outputs the received parameter to the parameter change unit 560.

The parameter change unit 560 changes the parameter in the transmission of a radio signal by the base station 500 by notifying the data processing unit 580 of the parameter output from the controller communication unit 550.

The network communication unit 570 receives data in downlink transmitted from the core network 470 (see FIG. 4). In addition, the network communication unit 570 outputs the received data to the data processing unit 580. In addition, the network communication unit 570 transmits data in uplink output from the data processing unit 580 to the core network 470.

The data processing unit 580 outputs the data in uplink output from the demodulation and decoding unit 520 to the network communication unit 570. In addition, the data processing unit 580 outputs the data in downlink output from the network communication unit 570 to the coding and modulation unit 590 so as to transmit the data by a sub-frame indicated by the scheduling information output from the scheduler operation unit 540. In addition, the data processing unit 580 changes the parameter in the transmission of a radio signal by the base station 500 using the parameter output from the parameter change unit 560.

The coding and modulation unit 590 encodes the data output from the data processing unit 580 and modulates the encoded signal. In addition, the coding and modulation unit 590 outputs the signal obtained by the modulation to the RF unit 510. In addition, the base station 500 may calculate a modulation and coding scheme (MCS) after the parameter given from the controller 460 is applied.

(Configuration of the Controller)

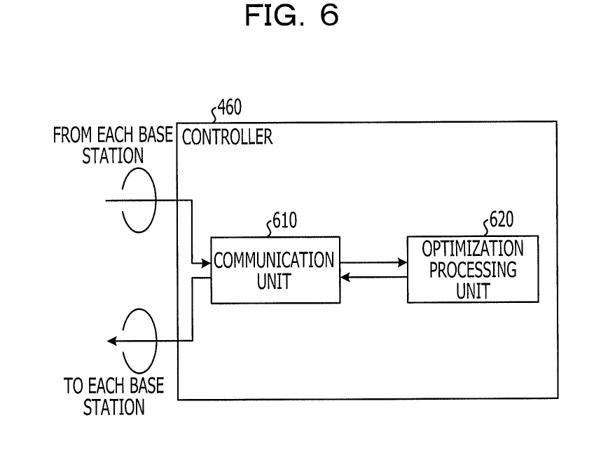

FIG. 6 is a diagram illustrating an example of a configuration of the controller. As illustrated in FIG. 6, the controller 460 includes, for example, a communication unit 610 and an optimization processing unit 620. The obtaining unit 141 and the control unit 143 that are illustrated in FIG. 1 can be realized, for example, by the communication unit 610. The calculation unit 142 illustrated in FIG. 1 can be realized, for example, by the optimization processing unit 620.

The communication unit 610 receives information transmitted from each of the base stations. The information transmitted from each of the base stations includes, for example, scheduling information, the number of mobile stations that are being coupled to the base station, and a propagation loss, etc. The communication unit 610 outputs the received information to the optimization processing unit 620. In addition, the communication unit 610 transmits the parameter of each of the base stations output from the optimization processing unit 620, to the corresponding target base station.

The optimization processing unit 620 performs optimization calculation by which a parameter in each base station is calculated, based on the scheduling information output from the communication unit 610. For the optimization calculation, for example, information output from the communication unit 610 such as the number of mobile stations and a propagation loss may be used. The optimization processing unit 620 outputs the parameter of each base station calculated by the optimization calculation to the communication unit 610.

(Operations of the Communication System)

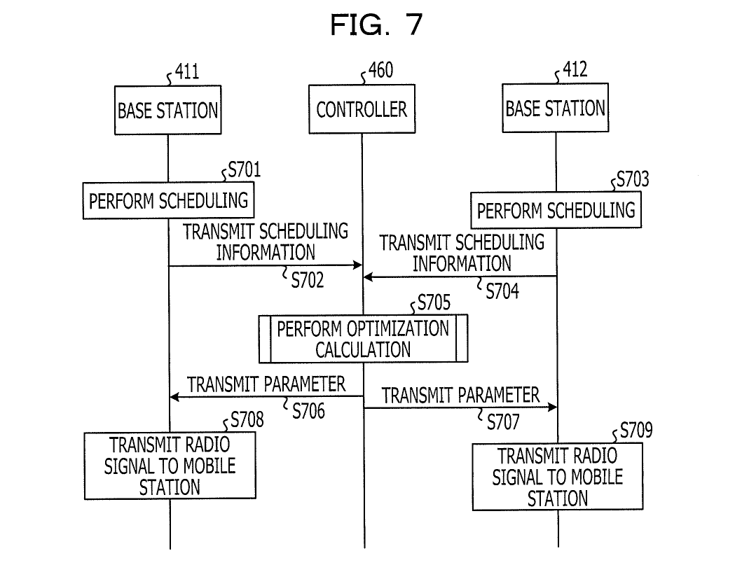

FIG. 7 is a sequence diagram illustrating an example of operations of the communication system. In the communication system 400 illustrated in FIG. 4, for example, the following steps are executed for each sub-frame. The operation related to the base stations 411 and 412 are described below.

As illustrated in FIG. 7, first, the base station 411 performs scheduling so as to allocate a mobile station that is being coupled to the base station 411, to a target sub-frame (Step S701). After that, the base station 411 transmits scheduling information that indicates a result of the scheduling obtained in Step S701, to the controller 460 (Step S702).

In addition, the base station 412 performs scheduling so as to allocate a mobile station that is being coupled to the base station 412 to a target sub-frame (Step S703). After that, the base station 412 transmits scheduling information that indicates a result of the scheduling obtained in Step S703, to the controller 460 (Step S704).

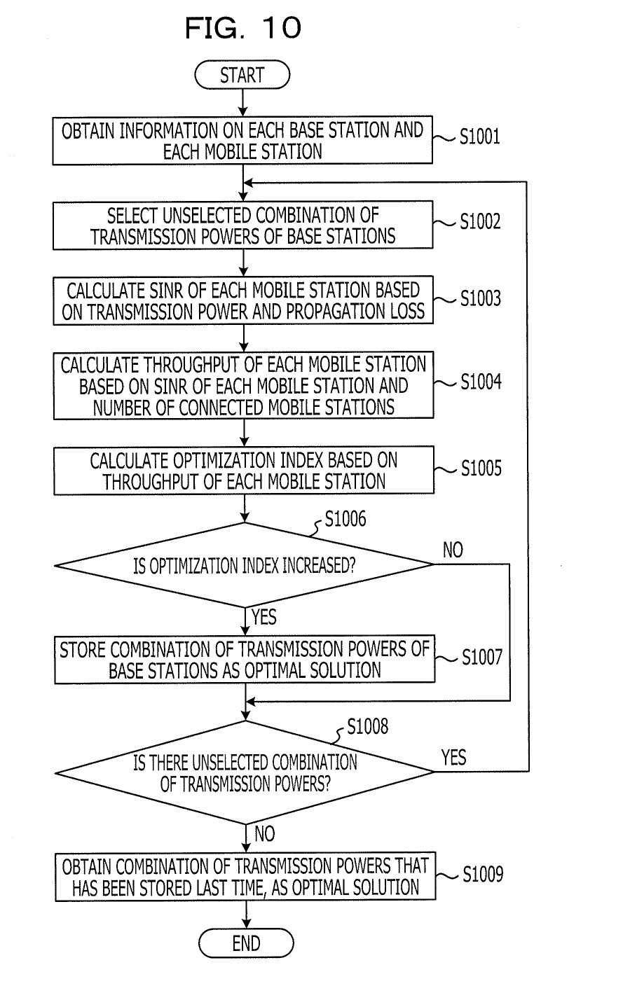

After that, the controller 460 calculates a parameter that optimizes the throughput of each of the mobile stations allocated to the corresponding target sub-frame by performing optimization calculation based on pieces of scheduling information transmitted in Steps S702 and S704 (Step S705). The optimization calculation in Step S705 is described later (for example, see FIG. 10).

After that, the controller 460 transmits the parameter of the base station 411 obtained by the optimization calculation in Step S705 to the base station 411 (Step S706). In addition, the controller 460 transmits the parameter of the base station 412 obtained by the optimization calculation in Step S705 to the base station 412 (Step S707).

After that, the base station 411 transmits a radio signal to the mobile station allocated to the target sub-frame by the scheduling in Step S701, using the parameter transmitted from the controller 460 in Step S706 (Step S708).

In addition, the base station 412 transmits a radio signal to the mobile station allocated to the target sub-frame by the scheduling in Step S703, using the parameter transmitted from the controller 460 in Step S707 (Step S709).

By the above-described steps, the transmission of the radio signal in the target sub-frame can be performed using the parameter that optimizes the throughput of each of the mobile stations allocated to the target sub-frame by each of the base stations 411 and 412.

In addition, the above-described steps are performed for each sub-frame, and the scheduling information of each sub-frame is transmitted to the controller 460. The controller 460 obtains the sub-frame number included in the received scheduling information and identifies each scheduling information from the base stations 411 and 412 for the same sub-frame.

In addition, the controller 460 performs optimization calculation based on each identified scheduling information. As a result, a parameter that optimizes the throughput of each mobile station allocated to the same sub-frame can be calculated even when scheduling information from the base stations 411 and scheduling information from the base station 412 are transmitted asynchronously.

(Scheduling in Each of the Base Stations)

A proportional fair (PF) system, for example, may be used for scheduling in the scheduler operation unit 540 of the base station 500. In the PF system, a mobile station is selected based on expectation instantaneous data rate against a time average data rate at a certain period. Thus, a mobile station having a high expectation instantaneous data rate is selected. Therefore, the base station 500 uses interference information such as a channel quality indicator (CQI) and a precoding matrix indicator (PMI) transmitted from a mobile station that is being coupled to the base station.

In addition, in order to equalize a frequency resource amount allocated for each mobile station, a Round Robin (RR) system in which mobile stations to be allocated are selected in order may be used for the scheduling in the scheduler operation unit 540.

The scheduler operation unit 540 performs scheduling for a future sub-frame after transmission of scheduling information to the controller 460, optimization calculation in the controller 460, transmission of a parameter from the controller 460 to each base station. For example, the scheduler operation unit 540 predicts a communication quality between the base station 500 and each of the mobile stations in a sub-frame that is a target to be scheduled and performs scheduling based on the prediction result.

(Example of Scheduling that Takes a Time Difference into Account)

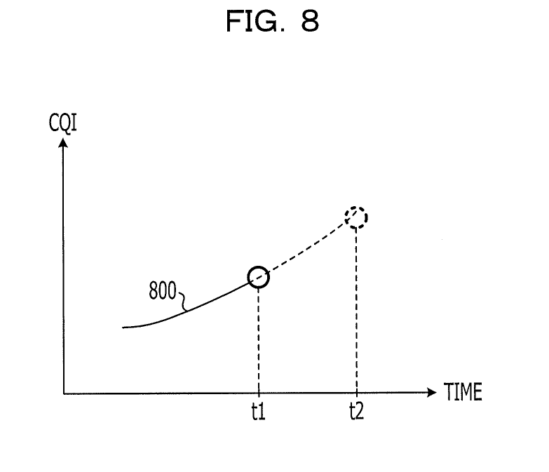

FIG. 8 is a diagram illustrating a first example of scheduling that takes a time difference into account. The horizontal axis in FIG. 8 indicates a time. The vertical axis in FIG. 8 indicates a CQI in wireless communication between the base station 500 and a mobile station. The time t1 indicates a current time, and the time t2 indicates a time of a sub-frame that is a target to be scheduled. CQI 800 indicates a CQI at each time.

For example, the scheduler operation unit 540 obtains a CQI at each time before the time t1, and calculates the change amount (for example, slope of the graph) of the CQI. In addition, the scheduler operation unit 540 multiplies the calculated change amount by a time period (t2−t1) between the time t1 and time t2 and can predict an approximate CQI at the time t2 by adding the multiplication result to the CQI at the time t1.

In addition, the scheduler operation unit 540 calculates an average value of a CQI during a certain time period immediately before the time t1 and may predict the calculated average value as a CQI at the time t2. The case of using a CQI is described above, and alternatively, a PMI may be used instead of a CQI.

As described above, the base station 500 obtains a communication quality between the base station 500 and a mobile station at each past time and predicts a communication quality between the base station 500 and the mobile station in each sub-frame based on the obtained communication quality. As a result, scheduling based on the predicted communication quality can be performed for a future sub-frame in which the time taken to transmit scheduling information, perform optimization calculation, transmit a parameter, etc. is considered.

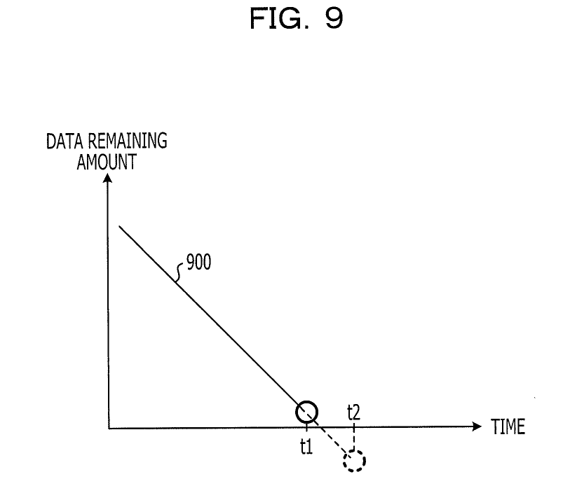

FIG. 9 is a diagram illustrating a second example of scheduling that takes a time difference into account. The horizontal axis in FIG. 9 indicates a time. The vertical axis in FIG. 9 indicates a remaining amount of data to be transmitted to a target mobile station. In the horizontal axis, the time t1 indicates a current time, and the time t2 indicates a time of a sub-frame that is a target to be scheduled. A data remaining amount 900 indicates a remaining amount of data to be transmitted to the target mobile station at each time.

The scheduler operation unit 540 obtains a remaining amount of data (remaining amount information) at each time before the time t1 for each mobile station that is being coupled to the base station 500 and calculates the change amount of the remaining amount of data. In addition, the scheduler operation unit 540 multiplies the calculated change amount by a time period (t2−t1) between the time t1 and the time t2 and can predict an approximate remaining amount of data at the time t2 by adding the multiplication result to the remaining amount of data at the time t1.

In addition, the scheduler operation unit 540 calculates an average value of a remaining amount of data at certain time period immediately before the time t1 and may predict the calculated remaining amount of data as a remaining amount of data at the time t2. As a result, the scheduler operation unit 540 can predict the presence or absence of data to be transmitted to a target mobile station at the time t2.

The scheduler operation unit 540 selects a mobile station from mobile stations to which the presence of the data to be transmitted in a target sub-frame is predicted, among mobile stations that are being coupled to the base station 500 when scheduling is performed.

As a result, the scheduler operation unit 540 determines a mobile station to which data to be transmitted remains as a target to be scheduled, for a future sub-frame in which the time taken to transmit scheduling information, perform optimization calculation, transmit a parameter, etc. is considered. As a result, such a situation that a time resource is wasted because data to be transmitted to the mobile station does not remain can be avoided in a sub-frame allocated to a mobile station.

(Optimization Calculation by the Controller)

FIG. 10 is a flowchart illustrating an example of optimization calculation by the controller. The controller 460 executes, for example, the following steps as the optimization calculation of Step S705 illustrated in FIG. 7. First, the controller 460 obtains information of each of the base stations (base stations 411 and 412) and each of the mobile stations (mobile stations 431 to 437) from the base stations 411 and 412 (Step S1001). The information obtained in Step S1001 includes, for example, the number of mobile stations that are being coupled to each base station and a propagation loss of a mobile station that is being coupled to each base station.

After that, the controller 460 selects an unselected combination of transmission powers of the base stations (Step S1002). After that, the controller 460 calculates an SINR of each of the mobile stations based on the transmission power of the base station that is being selected and the propagation loss of each of the mobile stations obtained in Step S1001 (Step S1003).

After that, the controller 460 calculates a throughput of each mobile station, based on the SINR of each mobile station calculated in Step S1003 and the number of mobile stations obtained in Step S1001 (Step S1004). After that, the controller 460 calculates an optimization index based on the throughput of each of the mobile stations calculated in Step S1004 (Step S1005). The optimization index includes, for example, an average throughput and a minimum throughput of the mobile stations.

After that, the controller 460 determines whether or not the optimization index calculated in Step S1005 is increased from an optimization index that has been stored as an optimal solution in past Step S1007 (Step S1006). However, in Step S1006 for the first time, the controller 460 determines an optimization index is increased.

In Step S1006, when the optimization index is not increased from an optimization index that has been stored as an optimal solution in past Step S1007 (Step S1006: No), the controller 460 proceeds to Step S1008. When the optimization index is increased from an optimization index that has been stored as an optimal solution in past Step S1007 (Step S1006: Yes), the controller 460 stores in a memory the combination of transmission powers of the base stations that is being selected as an optimal solution (Step S1007). After that, the controller 460 determines whether or not there is a combination of transmission powers of the base stations that has not been selected in Step S1002 (Step S1008).

In Step S1008, when there is an unselected combination (Step S1008: Yes), the controller 460 returns to Step S1002. When there is no unselected combination (Step S1008: No), the controller 460 obtains the combination of transmission powers of the base stations that has been stored in last Step S1007 as an optimal solution (Step S1009), and a series of steps of the optimization calculation ends.

As described above, the controller 460 calculates SINRs and throughputs for all combinations of parameters on which the optimization is performed, and selects a combination pattern in which the optimization index becomes maximum as an optimal solution. The controller 460 transmits each of the transmission powers obtained in Step S1009 of FIG. 10 to the base stations 411 and 412 as a parameter in Steps S706 and S707 illustrated in FIG. 7.

(Optimization of a Parameter)

Next, the optimization of a parameter is described.

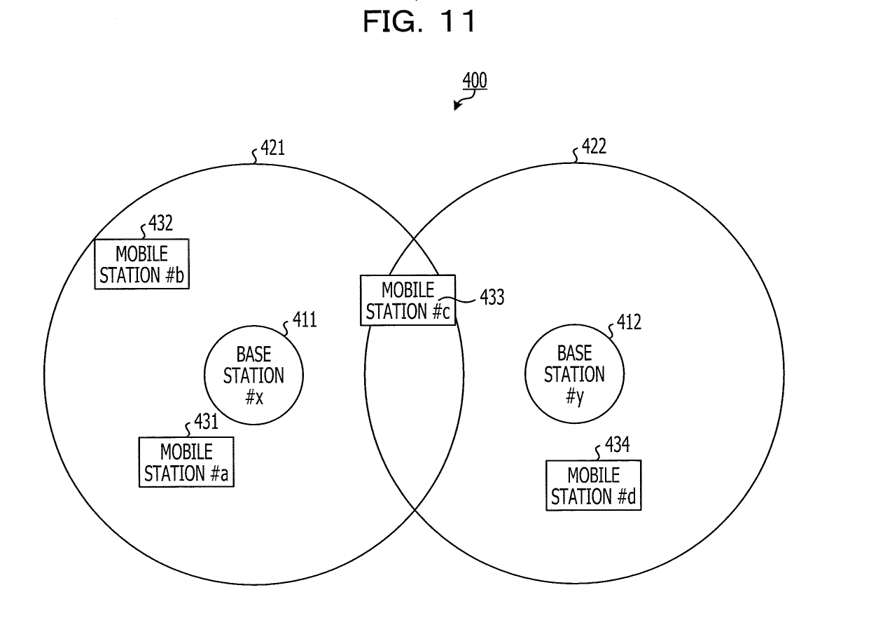

FIG. 11 is a diagram illustrating an example of cell placement in the communication system. In FIG. 11, parts similar to the parts illustrated in FIG. 4 are denoted by the same reference numerals, and the description thereof is omitted. As illustrated in FIG. 11, in the communication system 400, the mobile stations 431 and 432 are located in the cell 421. In addition, the mobile station 433 is located in an overlapping portion between the cell 421 and the cell 422. In addition, the mobile station 434 is located in the cell 422. The mobile stations 431 and 432 are coupled to the base station 411, and the mobile stations 433 and 434 are coupled to the base station 412.

Here, the base stations 411 and 412 are indicated by #x and #y, respectively, the mobile stations 431 to 434 are indicated by #a to #d, respectively. In addition, propagation losses in wireless communication between the base station 411 (#x) and the mobile stations 431 to 434 (#a to #d) are indicated by PLxa to PLxd [dB], respectively. Propagation losses in wireless communication between the base station 412 (#y) and the mobile stations 431 to 434 (#a to #d) are indicated by PLya to PLyd [dB], respectively.

SINRs in the mobile stations 431 to 434 (#a to #d) are indicated by SINRa to SINRd [dB], respectively. Throughputs in the mobile stations 431 to 434 (#a to #d) are indicated by Ta to Td, respectively.

<Optimization of Transmission Power>

The controller 460 optimizes, for example, transmission powers of the base stations 411 and 412 as parameters of the base stations 411 and 412 (#x and #y). When the transmission powers in the base stations 411 and 412 (#x and #y) are indicated by Px and Py [dBm], respectively, the SINRa to SINRd of the mobile stations 431 to 434 (#a to #d) can be expressed, for example, by the following formula (1). The N[dB] indicates a thermal noise power.

$$SINRa = 10 \cdot {log}_{10} ( \frac{{10}^{( Px - 30 - PLxa ) / 10}}{{10}^{( Py - 30 - PLya ) / 10} + {10}^{N / 10}} ) \\ SINRb = 10 \cdot {log}_{10} ( \frac{{10}^{( Px - 30 - PLxb ) / 10}}{{10}^{( Py - 30 - PLyb ) / 10} + {10}^{N / 10}} ) \\ SINRc = 10 \cdot {log}_{10} ( \frac{{10}^{( Py - 30 - PLyc ) / 10}}{{10}^{( Px - 30 - PLxc ) / 10} + {10}^{N / 10}} ) \\ SINRd = 10 \cdot {log}_{10} ( \frac{{10}^{( Py - 30 - PLyd ) / 10}}{{10}^{( Px - 30 - PLxd ) / 10} + {10}^{N / 10}} ) \qquad ( 1 )$$

Two mobile stations are individually coupled to the base station 411 (#x) and the base station 412 (#y), and a sub-frame is equally divided for the two mobile station. The throughputs Ta to Td in the mobile stations 431 to 434 (#a to #d) can be expressed, for example, by the following formula (2). The BW [Hz] indicates a transmission bandwidth.

$$Ta = \frac{1}{2} \cdot BW \cdot {log}_{2} ( 1 + {10}^{SINRa / 10} ) \\ Tb = \frac{1}{2} \cdot BW \cdot {log}_{2} ( 1 + {10}^{SINRb / 10} ) \\ Tc = \frac{1}{2} \cdot BW \cdot {log}_{2} ( 1 + {10}^{SINRc / 10} ) \\ Td = \frac{1}{2} \cdot BW \cdot {log}_{2} ( 1 + {10}^{SINRd / 10} ) \qquad ( 2 )$$

In addition, in terms of throughput uniformity, for example, as expressed by the following formula (3), the combination of transmission powers Px and Py can be calculated as an optimal solution so that the optimization index Z (Px, Py) becomes maximum. As a result, the transmission powers Px and Py in the base stations 411 and 412 (#x and #y) in which minimum values of throughputs Ta to Td in the mobile stations 431 to 434 (#a to #d) are maximized can be calculated as optimal solutions.

Z=min(Ta,Tb,Tc,Td) (3)

<Optimization of a Beam Pattern>

The controller 460 may optimize, for example, beam patterns (weighting factors of beam forming) of the base stations 411 and 412 as parameters of the base stations 411 and 412 (#x and #y). In a case in which the weighting factors of beam forming are indicated by wx and wy, respectively, when equivalent average transmission powers from the base station 411 (#x) to the mobile stations 431 to 434 (#a to #d) are indicated by Pxa (wx) to Pxd (wx) and equivalent average transmission powers from the base station 412 (#y) to the mobile stations 431 to 434 (#a to #d) are indicated by Pya (wy) to Pyd (wy), the SINRa to SINRd of the mobile stations 431 to 434 (#a to #d) can be expressed, for example, by the following formula (4).

$$SINRa = 10 \cdot {log}_{10} ( \frac{{10}^{( Pxa - 30 - PLxa ) / 10}}{{10}^{( Pya - 30 - PLya ) / 10} + {10}^{N / 10}} ) \\ SINRb = 10 \cdot {log}_{10} ( \frac{{10}^{( Pxb - 30 - PLxb ) / 10}}{{10}^{( Pyb - 30 - PLyb ) / 10} + {10}^{N / 10}} ) \\ SINRc = 10 \cdot {log}_{10} ( \frac{{10}^{( Pyc - 30 - PLyc ) / 10}}{{10}^{( Pxc - 30 - PLxc ) / 10} + {10}^{N / 10}} ) \\ SINRd = 10 \cdot {log}_{10} ( \frac{{10}^{( Pyd - 30 - PLyd ) / 10}}{{10}^{( Pxd - 30 - PLxd ) / 10} + {10}^{N / 10}} ) \qquad ( 4 )$$

The controller 460 calculates the throughputs Ta to Td in the mobile stations 431 to 434 (#a to #d) using the formulas (4), (2), and (3), and calculates the combination of weighting factors wx and wy as an optimal solution of a beam pattern so that the optimization index Z (wx, wy) becomes maximum by the formula (3).

<Optimization of a Transmission Frequency Bandwidth>

The controller 460 may optimize, for example, transmission frequency bandwidths (for example, resource blocks) of the base stations 411 and 412 as the parameters of the base stations 411 and 412 (#x and #y). When usage ratios of transmission bandwidths in the mobile stations 431 to 434 (#a to #d) are indicated by Ra to Rd, respectively, the following formula (5) is obtained from the formula (2). The usage ratios Ra to Rd satisfy the following formula (6).

Ta=Ra·BW·log₂(1+10^{SINRa/10})

Tb=Rb·BW·log₂(1+10^{SINRb/10})

Tc=Rc·BW·log₂(1+10^{SINRc/10})

Td=Rd·BW·log₂(1+10^{SINRd/10}) (5)

Ra+Rb=Rc+Rd=1 (6)

The controller 460 calculates the throughputs Ta to Td in the mobile stations 431 to 434 (#a to #d) using the formula (5), and calculates the combination among the Ra to Rd as an optimal solution by the formula (3) so that the optimization index Z (Ra, Rb, Rc, Rd) becomes maximum. As a result, the usage ratios Ra to Rd of the transmission bandwidths in the mobile stations 431 to 434 (#a to #d) in which minimum values of the throughputs Ta to Td in the mobile stations 431 to 434 (#a to #d) are maximized can be calculated optimal solutions.

<Optimization of Coordinated Transmission Between the Base Stations>

The controller 460 may optimize, for example, parameters related to a technology of coordinated transmission between the base stations as parameters of the base stations 411 and 412 (#x and #y). Coordinated scheduling (CS) is described below as an example of Cooperative Multipoint (CoMP). When the SINRa to SINRd of the mobile stations 431 to 434 (#a to #d) are calculated by assuming that CS is applied to the mobile station 431 (#a), the following formula (7) is obtained.

$$SINRa = 10 \cdot {log}_{10} ( \frac{{10}^{( Px - 30 - PLxa ) / 10}}{{10}^{N / 10}} ) \\ SINRb = 10 \cdot {log}_{10} ( \frac{{10}^{( Px - 30 - PLxb ) / 10}}{{10}^{( Py - 30 - PLyb ) / 10} + {10}^{N / 10}} ) \\ SINRc = 10 \cdot {log}_{10} ( \frac{{10}^{( Py - 30 - PLyc ) / 10}}{{10}^{( Px - 30 - PLxc ) / 10} + {10}^{N / 10}} ) \\ SINRd = 10 \cdot {log}_{10} ( \frac{{10}^{( Py - 30 - PLyd ) / 10}}{{10}^{( Px - 30 - PLxd ) / 10} + {10}^{N / 10}} ) \qquad ( 7 )$$

Due to CS, the base station 412 (#y) does not use the transmission band of the mobile station 431 (#a), and the transmission bandwidth available for the mobile stations 433 and 434 (#c and #d) is halved. Thus, the throughputs Ta to Td of the mobile stations 431 to 434 (#a to #d) are obtained as expressed by the following formula (8).

$$Ta = \frac{1}{2} \cdot BW \cdot {log}_{2} ( 1 + {10}^{SINRa / 10} ) \\ Tb = \frac{1}{2} \cdot BW \cdot {log}_{2} ( 1 + {10}^{SINRb / 10} ) \\ Tc = \frac{1}{4} \cdot BW \cdot {log}_{2} ( 1 + {10}^{SINRc / 10} ) \\ Td = \frac{1}{4} \cdot BW \cdot {log}_{2} ( 1 + {10}^{SINRd / 10} ) \qquad ( 8 )$$

The controller 460 calculates, for example, each optimization index Z as expressed by the following formula (9) in a case in which CS is applied to the mobile stations 431 to 434 (#a to #d), and calculates a mobile station that is an application destination of CS as an optimal solution so that the optimization index Z becomes maximum. As a result, parameters of CS that uniformizes throughputs can be calculated.

Z=min(Ta,Tb,Tc,Td) (9)

In addition, the controller 460 may control a base station that performs CoMP as a parameter. As described above, each of the base stations performs CoMP, and the controller 460 may optimize a parameter related to CoMP. In addition, the controller 460 may optimize a combination of the above-described various parameters.

(Specific Example of Optimization of a Parameter)

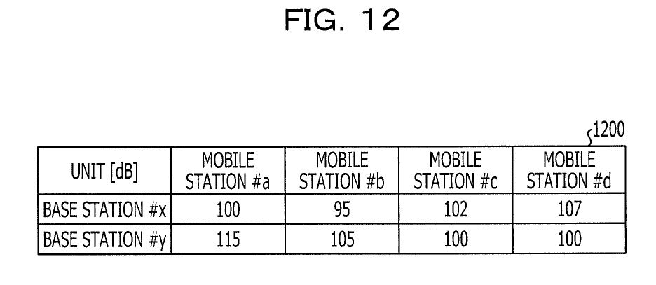

FIG. 12 is a diagram illustrating an example of a propagation loss between a base station and each of the mobile stations. Propagation loss information 1200 in FIG. 12 indicates a propagation loss in each combination of the base stations 411 and 412 (#x and #y) and the mobile stations 431 to 434 (#a to #d). The controller 460 obtains the propagation loss information 1200 from the base stations 411 and 412.

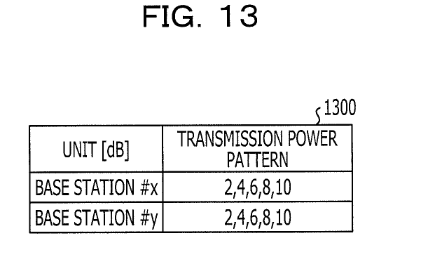

FIG. 13 is a diagram illustrating an example of a transmission power pattern in each of the base stations. Transmission power pattern information 1300 in FIG. 13 indicates a transmission power pattern (candidate of a combination of transmission powers) in the base stations 411 and 412 (#x and #y). The transmission power pattern information 1300 is stored, for example, in the memory 322 of the controller 460 (see FIG. 3B). When the controller 460 optimizes the transmission powers Px and Py of the base stations 411 and 412 (#x and #y) as parameters, the controller 460 calculates an optimal combination among combinations of the transmission powers Px and Py indicated by the transmission power pattern information 1300.

When, for a certain sub-frame, the mobile station 431 (#a) is scheduled in the base station 411 (#x) and the mobile station 433 (#c) is scheduled in the base station 412 (#y), scheduling information in each of the base stations 411 and 412 (#x and #y) is transmitted to the controller 460 with a sub-frame number.

The controller 460 confirms that the scheduling information transmitted from the base station 411 and the scheduling information transmitted from the base station 412 (#x and #y) have the same sub-frame number and performs optimization of the mobile stations 431 and 433 (#a and #c). The SINRa and SINRc in the mobile stations 431 and 433 (#a and #c) when the transmission powers Px and Py of the base stations 411 and 412 (#x and #y) is 2 [dBm] are obtained from the formula (1) as expressed in the following formula (10).

$$SINRa = 10 \cdot {log}_{10} ( \frac{{10}^{( Px - 30 - PLxa ) / 10}}{{10}^{( Py - 30 - PLya ) / 10} + {10}^{N / 10}} ) = 0.48 [ dB ] \\ SINRc = 10 \cdot {log}_{10} ( \frac{{10}^{( Py - 30 - PLyc ) / 10}}{{10}^{( Px - 30 - PLxc ) / 10} + {10}^{N / 10}} ) = - 1.74 [ dB ] \qquad ( 10 )$$

When the BW is 4.32 [MHz], the throughputs Ta and Tc of the mobile stations 431 and 433 (#a and #c) are obtained from the formulas (10) and (2) as expressed in the following formula (11).

Ta=BW·log₂(1+10^{SINRa/10})=4.68 [Mbps]

Tc=BW·log₂(1+10^{SINRc/10})=3.19 [Mbps] (11)

The optimization index Z (2, 2) can be obtained from the formulas (11) and (3) as expressed in the following formula (12).

Z(2,2)=min(Ta, Tc)=3.19 [Mbps] (12)

Similarly, in a case in which an optimization index Z is calculated for another transmission power pattern, when Px is equal to 6 [dBm] and Py is equal to 10 [dBm], the optimization index Z (6, 10) is obtained as expressed in the following formula (13) to maximize the optimization index Z.

Z(6,10)=min(Ta, Tc)=7.56 [Mbps] (13)

Therefore, the controller 460 can obtain the transmission powers Px=6 [dBm] and Py=10 [dBm] of the base stations 411 and 412 (#x and #y) as optimal solutions.

Similarly, in another sub-frame, the mobile station 432 (#b) is scheduled in the base station 411 (#x), and the mobile station 434 (#d) is scheduled in the base station 412 (#y). In this case, the optimization index Z becomes maximum in the following formula (14). Therefore, the controller 460 can obtain transmission powers Px=8 [dBm] and Py=10 [dBm] of the base stations 411 and 412 (#x and #y) as optimal solutions.

Z(8,10)=min(Tb, Td)=9.79 [Mbps] (14)

As described above, for each sub-frame, different optimal solution is obtained depending on combination of scheduled mobile stations, so that the effect of improving the throughput can be obtained in each of the sub-frames.

(Exemplary Application of Parameter Control in Uplink)

The case is described above in which the control device 140 (the controller 460) controls the parameters in downlink, and alternatively, the control device 140 may control parameters of the mobile stations 131 to 138 in uplink. In this case, the control device 140 controls the parameters of the mobile stations 131 to 138 by transmitting the calculated parameters of the mobile stations 131 to 138 to the mobile stations 131 to 138 through the base stations 411 and 412.

In each sub-frame, each of the mobile stations 131 to 138 transmits a radio signal to a base station to which the mobile station is coupled, among the base stations 411 and 412 using the parameter of the mobile station calculated by the control device 140.

The parameter in uplink includes, for example, a transmission power of a radio signal from each of the mobile stations 131 to 138 to the base stations 110 and 120, and a transmission frequency bandwidth of a radio signal from each of the mobile stations 131 to 138 to the base stations 110 and 120.

In this case, for example, each of the base stations 411 and 412 may predict the presence or absence of data to be received from mobile stations that are coupled to the base station for each sub-frame. In addition, each of the base stations 411 and 412 selects a mobile station from which a radio signal is to be transmitted, from mobile stations for which the presence of data to be received is predicted in a target sub-frame, among mobile stations that are coupled to the base station.

As a result, a mobile station in which data to be received by the base station remains can be determined as a target to be scheduled for a future sub-frame in which the time taken to transmit scheduling information, perform optimization calculation, transmit a parameter, etc. is considered. As a result, in a sub-frame allocated to a mobile station, such situation that a time resource is wasted because data to be received from the mobile station does not remain can be avoided in a sub-frame allocated to a mobile station.

As described above, in the communication system, the communication method, the control device, and the base station according to the embodiments, throughputs can be stably improved even when there are many mobile stations.

All examples and conditional language recited herein are intended for pedagogical purposes to aid the reader in understanding the invention and the concepts contributed by the inventor to furthering the art, and are to be construed as being without limitation to such specifically recited examples and conditions, nor does the organization of such examples in the specification relate to a showing of the superiority and inferiority of the invention. Although the embodiments of the present invention have been described in detail, it should be understood that the various changes, substitutions, and alterations could be made hereto without departing from the spirit and scope of the invention.

What is claimed is:

1. A communication system comprising:
a plurality of mobile stations each of which performs wireless communication with a base station;
a plurality of base stations each of which selects, for each transmission timing, a mobile station which performs wireless communication for transmission of a radio signal with the base station, from mobile stations that are coupled to the base station among the plurality of mobile stations; and
a control device that calculates, for each transmission timing, a parameter for each of a communication source in the transmission of the radio signal, the parameter being calculated so that a communication quality of each of the mobile stations selected for the transmission timing by each of the plurality of base stations satisfies a certain condition; wherein
the each of the communication source transmits the radio signal at each transmission timing, using a parameter for the communication source calculated by the control device.

2. The communication system according to claim 1, wherein
the each of the plurality of base stations selects the mobile station that is a transmission destination of the radio signal, and
the control device calculates the parameter for each of the plurality of base stations as the each of the communication source in the transmission of the radio signal, and
the each of the plurality of base stations transmits the radio signal to the mobile station selected by the base station, using the parameter for the base station calculated by the control device.

3. The communication system according to claim 2, wherein
each of the plurality of base stations generates selection information for each transmission timing, the selection information associating the selected mobile station with the transmission timing for which the mobile station is selected as the transmission destination, and
the control device calculates a parameter in which a communication quality of each of the mobile stations that are associated with the transmission timing in the selection information generated by each of the plurality of base stations satisfies the certain condition.

4. The communication system according to claim 2, wherein
the base station predicts a communication quality between the base station and the mobile station that is coupled to the base station for each transmission timing and selects a mobile station that is the transmission destination based on the predicted communication quality.

5. The communication system according to claim 4, wherein
the base station obtains a communication quality at each past time between the base station and the mobile station that is coupled to the base station and predicts a communication quality for each transmission timing based on the obtained communication quality.

6. The communication system according to claim 2, wherein
the base station predicts, for each transmission timing, a presence or absence of data to be transmitted to the mobile station that is coupled to the base station, and selects the mobile station that is the transmission destination, from the mobile stations to which the presence of the data to be transmitted is predicted at the transmission timing, among the mobile stations that are coupled to the base station.

7. The communication system according to claim 6, wherein
the base station obtains remaining amount information that indicates a remaining amount of the data to be transmitted at each past time, and predicts the presence or absence of the data for each transmission timing based on the obtained remaining amount information.

8. The communication system according to claim 2, wherein
the parameter includes at least one of a transmission power of a radio signal from the base station, a beam pattern of a radio signal from the base station, and a transmission frequency bandwidth of a radio signal from the base station.

9. The communication system according to claim 2, wherein
the plurality of base stations perform coordinated transmission between the base stations, and
the parameter includes a parameter related to the coordinated transmission between the base stations.

10. The communication system according to claim 1, wherein
the transmission timing is a sub-frame.

11. The communication system according to claim 1, wherein
the control device is provided in one of the plurality of base stations.

12. The communication system according to claim 1, wherein
the each of the plurality of base stations selects the mobile station from which the radio signal is transmitted to the base station, and
the control device that calculates the parameter for each of the plurality of mobile stations as the each of the communication source in the transmission of the radio signal, and
the each of the plurality of mobile stations transmits the radio signal to the base station to which the mobile station is coupled, using the parameter for the mobile station calculated by the control device.

13. The communication system according to claim 12, wherein
the parameter includes at least one of a transmission power of a radio signal from the mobile station, a beam pattern of a radio signal from the mobile station, and a transmission frequency bandwidth of a radio signal from the mobile station.

14. The communication system according to claim 12, wherein
the base station predicts, for each transmission timing, a presence or absence of data to be received from the mobile station that is coupled to the base station, and selects the mobile station from which a radio signal is transmitted to the base station, from the mobile stations to which the presence of the data to be received is predicted for the transmission timing, among the mobile stations that are coupled to the base station.

15. A communication method comprising:
selecting for each transmission timing, by each of a plurality of base stations, a mobile station which performs wireless communication for transmission of a radio signal with the base station, from mobile stations that are coupled to the base station among a plurality of mobile stations;
calculating for each transmission timing, a parameter for each of a communication source in the transmission of the radio signal, the parameter being calculated so that a communication quality of each of the mobile stations selected for the transmission timing by each of the plurality of base stations satisfies a certain condition; and
transmitting, at each transmission timing, the radio signal from each of the communication source, using a parameter for the communication source by the calculating.

16. A control device comprising:
a memory; and
a processor configured to execute a procedure in the memory, the procedure including:
an obtaining process that obtains selection information that indicates a result obtained by selecting for each transmission timing a mobile station which performs wireless communication for transmission of a radio signal with the base station, from mobile stations that are coupled to the base station among the plurality of mobile stations;
a calculation process that calculates for each transmission timing, based on the selection information, a parameter for each of a communication source in the transmission of the radio signal, the parameter being calculated so that a communication quality of each of the mobile stations selected for the transmission timing satisfies a certain condition; and
a control process that controls the each of the communication source to transmit the radio signal at each transmission timing, using a parameter for the communication source calculated by the control process.
